(19) United States
(12) Patent Application Publication
(10) Pub. No.: US 2015/0192800 A1
(43) Pub. Date: Jul. 9, 2015

(54) OPTIMIZATION OF LIGHT FILTERS AND ILLUMINANTS AND PRODUCTS DERIVED THEREFROM

(71) Applicants: Carl W. Dirk, El Paso, TX (US); Douglas J. Steele, Salt Lake City, UT (US)

(72) Inventors: Carl W. Dirk, El Paso, TX (US); Douglas J. Steele, Salt Lake City, UT (US)

(73) Assignees: PHOTOKINETICS, INC., Salt Lake City, UT (US); BOARD OF REGENTS, Austin, TX (US)

(21) Appl. No.: 14/414,071

(22) PCT Filed: Jul. 9, 2013
(86) PCT No.: PCT/US13/49641

§ 371 Date: Jan. 9, 2015

Related U.S. Application Data
(60) Provisional application No. 61/669,727, filed on Jul. 10, 2012.

(51) Int. Cl. G02C 7/10

(52) U.S. Cl. CPC G02C 7/10

(57) ABSTRACT

The invention is directed to improved methods of optimizing light for therapeutic or well-being effects. The invention also provides materials, methods, computer programs and systems for the creation and use of optimized Sight filters and illuminants. The methods of the present invention also include the use of optimized light filters and illuminants for use in treating diseases sensitive to modulation of intrinsically photosensitive retinal ganglion cells. The usefulness of the present method is that it results in the treatment of diseases and/or conditions related to light.

### TECHNICAL FIELD

The present invention relates generally to optimization of light for therapeutic or well-being effects and, more particularly to methods, compositions and systems for optimization of light filters and illuminants for use with, conditions or diseases that can be treated or prevented by modulation of the ipRGC response.

### BACKGROUND ART

The eye contains a population of rod cells for sensing intensity of light and three populations of cone cells for sensing color. A series of recent findings have shown that the eye possesses an additional population of photosensitive cells located in the retinal ganglion cellular layer, and known as Intrinsically-Photosensitive Retinal. Ganglion Cells (ipRGCs) or Melanopsin Cells, which mediate non-visual responses to Sight. These cells are responsive only to light of a wavelength range of approximately 460-520 nm. In addition, these cells form connections to a pathway projecting from the front of the retina to the Suprachiasmatic Nucleus and proximal Hypothalamic regions (including the Lateral and Anterior Nuclei, and the Sub-Paraventricular Zone), the Olivary Pretectal Nucleus, Intergeniculate Leaf and Dorso-lateral and Ventrolateral Geniculate Nuclei of the Thalamus, and a projection, pathway to the Medulla in the hind brain. This network appears not be used in vision, but in other physiological processes including entraining and maintaining circadian rhythms and the pupillary light reflex. Additionally, this network may also be associated with conditions including migraine headache, blepharospasm, and various photosensitivities. Current methods of treating these conditions involve the use of drugs, sunglasses, or behavioral changes (i.e., staying indoors in a darkened room for extended periods). Therefore, there is a need in the art for methods of manufacturing and employing products for treatment of conditions associated with the light stimulating this pathway. Products capable of affecting the ipRGC response would have the advantage of more effectively treating a variety of conditions.

### BRIEF SUMMARY OF THE INVENTION

Optical-filters, like eyewear and window coverings, and illuminants (light sources) are described herein that are optimized to provide a level of control of intrinsically photosensitive retinal ganglion cells (ipRGC). Optimization procedures are described herein to define the spectral, profile of these products which then can be manufactured using various processes. The optimization procedures, processes and methods can be embodied in a computer product, that performs the optimization and provides the spectral properties of the product. The optimization process involves selecting a desired response threshold and one or more additional, optical indices such as color rendering and/or luminous transmission and optimizing trial spectrum from a reference spectrum to yield an optimized product. The methods, compositions and systems for optimization of light filters and illuminants may be used with conditions or diseases that can be treated or prevented by modulation of the ipRGC response.

### BRIEF DESCRIPTION OF THE DRAWINGS

The following description can be better understood in light of the Figures, in which:

FIG. 1 illustrates a graph for ipRGC activity based on photon density according to an embodiment of the invention.

FIG. 2 illustrates an exemplary schematic of an eye according to an embodiment of the invention.

FIG. 3 illustrates a representative filter transmission spectral profile for filter design in accordance with embodiments as described herein.

FIG. 4 illustrates a representative filter transmission spectral profile for filter design in accordance with embodiments as described herein;

FIG. 5 illustrates a representative filter transmission spectral profile for filter design in accordance with embodiments as described herein;

FIG. 6 illustrates a representative filter transmission spectral profile for filter design in accordance with embodiments as described herein;

FIG. 7 illustrates a representative filter transmission spectral profile for filter design in accordance with embodiments as described herein; and

FIG. 8 illustrates an arbitrary spectral efficiency function for ipRGC response in accordance with an embodiment of the present invention.

The Figures illustrate specific aspects of the products and methods/systems for making such products. Together with the following description, the Figures demonstrate and explain the principles of the methods and compositions produced through these methods. In the drawings, the thickness of layers and regions are exaggerated for clarity. The same reference numerals in different drawings represent the same element, and thus their descriptions will not be repeated. As the terms “on”, “attached to”, or “coupled to” are used herein, one object (e.g., a material, a layer, a substrate, etc.) can be on, attached to, or coupled to another object regardless of whether the one object is directly on, attached, or coupled to the other object or there are one or more intervening objects between the one object and the other object. Also, directions (e.g., above, below, top, bottom, side, up, down, under, over, upper, lower, horizontal, vertical “x,” “y,” “z,” etc), if provided, are relative and provided solely by way of example and for ease of illustration and discussion and not by way of limitation. In addition, where reference is made to a list of elements (e.g., elements a, b, e), such reference is intended to include any one of the listed elements by itself, any combination of less than all of the listed elements, and/or a combination of all of the listed elements. Moreover, for the purpose of the present invention, the term “a” or “an” entity refers to one or more of that entity; for example, “a filter” or “an illuminant” refers to one or more of those compounds or at least one compound. As such, the terms “a” (or “an”), “one or more” and “at least one” can be used interchangeably herein. It is also to be noted that the terms “comprising”, “including”, and “having” can be used interchangeably. Furthermore., a compound “selected from the group consisting of” refers to one or more of the compounds in the list that follows, including mixtures (i.e. combinations) of two or more of the compounds.

### DISCLOSURE OF THE INVENTION

The following description supplies specific details in order to provide a thorough understanding of the methods, systems and optical filter products derived therefrom as described herein. Nevertheless, the skilled artisan would understand that the optical filter products and associated methods of making and using such optical filter products can be implemented and used without employing these specific details. Indeed, the optical filter products and associated methods/systems can be placed into practice by modifying the illustrated optical filter products and methods and can be used in conjunction with any other materials and techniques conventionally used in the industry. For example, while the description refers to ophthalmologic products and in particular aspects, eyewear and illuminants, it could be modified to be used with, or to develop any type of light titter or illuminant. For example, the methods described can be used in the design of glass or plastic filters that can be placed in front of an artificial light source (such as a bulb) such that as light passes through the filter, the desired wavelengths of light are blocked with a desired or optimized color rendering and luminous transmission. Similarly, these methods can he applied to the manufacture of thin-film materials that can be adhered to surfaces such as windows or computer screens. Other implementations will be readily apparent to the skilled artisan in view of this disclosure.

As disclosed herein, a methodology to simultaneously optimize the color rendering of the illumination or optical filter, the relative transmitted luminance of a filter and the ability to select the performance of the filter or illumination with respect to its ability to better control Intrinsically photosensitive retinal ganglion cell (ipRGC) activity is provided. Related optical products e.g., optical filters and illuminants are also provided. With regard to controlling light effects on ipRGC activity, this application involves a methodology that permits the development of products that would be commensurate with the protocols and needs of doctors and patients. For instance, the systems described herein allow for the identification and production of an ophthalmologic product which would completely attenuate ipRGC activity, or choose to permit, some activity up to full saturation, or at any desired level in between. Thus, ophthalmologic products are provided herein that completely attenuate RG activity or permit a selected ipRGC activity up to full saturation of ipRGC activity. The system described herein can also take into consideration the nature of the Sight source (e.g. sunlight, fluorescent, incandescent, LED, mercury vapor, halogen lamp, sodium lamp, electronic display) most commonly experienced by the patient, and can also adjust for the level of lighting. The system advantageously allows for adjustment of the spectral profile, lux level, and duration of exposure to die light source, thereby providing ophthalmologic products that provided for a selected level of ipRGC attenuation or activity based on the nature of light (spectral profile) and. the lux level. In addition, ophthalmologic products are provided that correct for scattered light which might not enter directly through the filters (e.g., lenses). For example, based on these optimizations, an ophthalmologic product can have side lighting shielding (similar to that present on common safety glasses) or fit firmly to the face in a wrap-around type product which excludes substantially all light except that which passes through the filter (e.g., lenses) to achieve a desired ipRGC attenuation or activity profile.

The methods and systems described herein can he used for the determination of desirable or optimized spectral profiles for optical products for any conditions or diseases that can be treated or prevented by modulation of the ipRGC response. Illustrative examples of diseases associated with ipRGC response include migraine, blepharospasm, traumatic brain injury, hypo- or hyper-secretion of hormones, dyslexia, post-traumatic stress disorder (PTSD), seasonal affective disorder (SAD), infant colic, anxiety disorders, fear or aversion disorders, emotional responses resulting from limbic afferent or efferent activation or inhibition, hyper-vigilance to environmental stimuli, direct and dissociative pain processes (including but not limited to nociceptive, neuropathic, phantom, psychogenic, breakthrough, and incident pain), photophobia resulting from proximal or distal organic or environmental factors, and excitation, inhibition, or disruption of dynamic balance between the Sympathetic and Parasympathetic divisions of the Autonomic Nervous System.

Remarkably, the methods described herein provide for the determination of the thresholds of applicability of products as described in greater detail below. This application uniquely defines what lighting levels appear suitable for use of inventions of the type related to treating or preventing conditions related to ipRGC response. One exciting result of these methods is the feature in that it provides both the correct (or optimized) product for a subject as well as define the correct (or optimized) the environment for the patient.

Selection of a product for the patient (e.g., subject) can involve embodiments of this invention in the form of ophthalmic glasses or lenses, specification of filtered or unfiltered lighting, or specification of window light or electronic display filtering, all of which can be defined by means of this invention. Products may be recommended or prescribed by a doctor or self-selected by the patient suffering from a condition. Therefore, the optical products have the selected characteristics may be provided to the subject or group of subjects as described herein.

### Definitions

What follows first are definitions of quantities and parameters used in the optimization process, as well, as a description of the optimization process. The optimization for color rendering and luminous transmission has been referred to in U.S. Pat. Nos. 7,663,739, 7,626,693 which are hereby incorporated by reference in their entireties.

Unless defined otherwise, all technical and scientific terms used herein have the same meaning as is commonly understood by one of ordinary skill in the art.

As used herein, the term “ipRGC response”, “ipRGC activity” refers to the signal transduced from light to a biological activity by the intrinsically photosensitive retinal ganglion cells. The transduced signal can be related to its action potential and/or other transduced signals such as stimulation or modulation of other parts of the brain or stimulation or modulation of e.g., hormone release or metabolism.

As used herein, “a condition or disease that can be treated or prevented by modulation of the ipRGC response” refers to any medical symptomatology or pathology of conditions associated with ipRGC response including but not limited to, migraine, blepharospasm, traumatic brain injury, hypo- or hyper-secretion of hormones, dyslexia, post-traumatic stress disorder (PTSD), seasonal affective disorder (SAD), infant colic, anxiety disorders, fear or aversion disorders, emotional responses resulting from Limbic afferent or efferent activation or inhibition, hyper-vigilance to environmental stimuli, direct and dissociative pain processes (including but not limited to nociceptive, neuropathic, phantom, psychogenic, breakthrough, and incident pain), photophobia resulting from proximal or distal organic or environmental factors, and excitation, inhibition., or disruption of dynamic balance between the Sympathetic and Parasympathetic divisions of the Autonomic Nervous System.

As used herein, the term “circadian patterning associated disorder” refers to a group of diseases or conditions associated with a disruption of an individual's circadian. cycle entrainment and/or maintenance. Treating or preventing circadian patterning disorders include, but are not limited to entrainment (setting or establishing the biorhythm), maintenance (keeping the biorhythm within a set of physiological parameters), and resetting (altering the endogenous biorhythm from one periodic schedule of physiological events to another). Treating or preventing circadian patterning disorders includes the treatment or prevention of diseases associated with disruptions in the circadian cycle.

As used herein, the term “optical product”, refers to an ophthalmologic product as defined below which include optical filters or illuminants (e.g., fight sources).

As used herein, the term “ophthalmologic product” or “ophthalmic product” refers to an optical filter. Ophthalmic products include e.g., prescription or non-prescription ophthalmic lenses used, for clear or tinted eyeglasses (or spectacles), sunglasses, goggles (e.g., sport or protective), contact lenses with and without visibility tinting or cosmetic tinting. Ophthalmic products can also include thin-film sheets that can be applied to windows or computer monitors for purposes of selectively filtering transmitted light. Ophthalmic products also include devices such as a corneal inlay or onlay that may be configured to filter light.

As used herein, the term “lens” or “lenses” refers to eyeglass lenses of a variety of shapes and sizes as well as shield style lenses that, may he part of goggles used for protection (e.g., safety) or sports. Lenses for a frame can be removable or interchangeable or can be an integral part of the frame.

As used herein, the term “frame” refers to blade-style frames, goggle-style frames including goggles, conventional frames, and any other style of eyewear frame.

As used herein, the term “color rendering” refers to the accuracy with which colors are rendered by one illuminant relative to a reference illuminant. Color Rendering Index (CRI) is an indication of how well the illuminant is matched to the reference illuminant, with a CRI=100 being a perfect match of the illuminant to the reference illuminant. For example, the CRI of filtered sunlight (e.g., sunlight filtered through an optical filter such as a sunglass lens) can be calculated relative to unfiltered sunlight (which would act as the reference illuminant), or can he calculated relative to a theoretical reference illuminant (e.g., Standard D65). CRI relates to color difference such that 4.6 CRI units are about equivalent to DE=1 color difference unit. In this way, just-perceptible changes in CRI occur between the following points: 100, 95.4, 90.8, 86.2, 81.6, and so on (even below zero in some instances). CRI can be determined by calculating color difference between the illuminant and the reference illuminant and applying adaptation models to determine the appropriate perceived CRI. CRI can be determined using CIE 13.3. However, CIE 13.3 is only specified here as an illustrative example of the means by which color rendering can be determined. Other color rendering methods using different color difference and color adaptation procedures can be used such as CRM09, CRI DE00-1.09 or any other formulation. In a particular embodiment, the CRI-109 method is defined here in which the color adaptation model of CIE 13.3 is replaced with that from CIE 109.2. In another particular embodiment, the CRI DE00-109 method is defined here in which the color difference method is DE00 (CIE 142) and the color adaptation method is taken from CIE 109.2

As used herein, the term “electronic display” refers to a display on an electronic device like a computer screen or monitor, television screen, an electronic notepad screen and the like. Examples of technologies that employed in electronic displays include but are not limited to CRT (cathode ray tube), LCD (liquid crystal display), plasma, LED (light emitting diode), OLED (organic light emitting diode), quantum dot, ELD (electroluminescent display) and laser (e.g., laser TV).

As used herein, the term “Luminance” generally refers to a photometric measure of the luminous intensity per unit area of light traveling in a given, direction. As used in this disclosure, “luminance” refers to wavelengths of light in the range that are perceptible to humans (e.g., of a visible sensation to humans) averaged over the visible spectrum of between about 360 nm and about 830 nm, weighted by the photopic function. As such, reduction in luminance of an optical filter may be described as the luminance of light from a reference illuminant filtered by the optical filter relative to the luminance of unfiltered light from the reference illuminant.

“Luminosity” refers to the perceived brightness of illumination. Luminosity (either as illuminance, luminance, or luminous intensity) can, for example, be calculated using (1) the Standard Vision Theory model in which luminosity is determined from luminance (Y), which is itself derived from the Photopic function; (2) the Helmholtz-Kohlrausch model in which luminosity may be determined from luminance (Y) and chromaticity (x,y); (3) the opponent color theory in which luminosity may be determined from L*a*b* coordinates; and/or (4) by empirical brightness determinations. Where reference is made to reducing luminance, it may, additionally or alternatively, include reducing luminosity, illuminance, luminous intensity, and/or reducing perceived brightness (theoretical and/or experimental). As several embodiments of the present invention deal with the development of illuminants, glasses, and possibly diffuse or specular reflecting surfaces, and product combinations there-of, the terminologies “luminance”, “illuminance”, or “luminous intensity” may be intermixed within this application. No limitation is implied when using luminous terminology apparently inconsistent with the product type.

A “predominant illuminant environment” refers to the profile of light that a subject is exposed to in a particular setting. For example, the predominant illuminant environment of e.g., a subject in an office setting can comprise sunlight that enters through a window in the office, the fluorescent or incandescent lights the illuminate the office and the light that is emitted from an electronic display (e.g., computer screen) in the office.

A “predominant illuminant” refers to the dominating profile of light that a subject is exposed to in a particular setting. For example, the predominant illuminant is the one that represents 50%, 60%, 70%, 80%, 90% or greater of the luminosity that the individual, is exposed to. Several factors are to be considered when, referring to a, “predominant illuminant” as detailed below:

(1) While these calculations are performed in terms of illuminance and irradiances, it is understood that this is a characterization of the lighting in an environment which may be measured using standard power or illuminance meters. This characterization is typical for lighting design, and does not require the specification of the source output (radiance, radiant intensity, luminance, luminance intensity) which produces the typical environmental illuminances and irradiances. It is presumed that the measured, irradiance or illuminance is that to which the unprotected eye is exposed, or that a proportionality exists between this value and the value which impacts the organs of the eye, so that the results presented here-in are proportionally correct.

(2) S(λ) is an irradiance spectral profile of the external illumination to which the

subject may be exposed, it may be sunlight, incandescent, fluorescent, an LED source or any other arbitrary source as described herein. For the purposes described herein, it is initially defined in units of W/m² if a continuous function, and in units of W/m²/nm if discrete.

(3) α is an adjustable parameter

(4) The standard spectral luminous photopic distribution is given by V(λ), (CIE S 010.2/E:2004, Photometry—The CIE System of Physical Photometry; CIE Central Bureau: Vienna, 2004). It is unit-less, and for the purposes described herein, it is scaled such that the maximum value is equal to 1. It may be replaced, as necessary, by the modified CIE 1988 2° spectral luminous function V_{M} (λ). (CIE 1988 2° Spectral Luminous Efficiency Function For Phototopic Vision, Publication CIE 86,” Commission Internationale de I'Éclairage, 1990.)

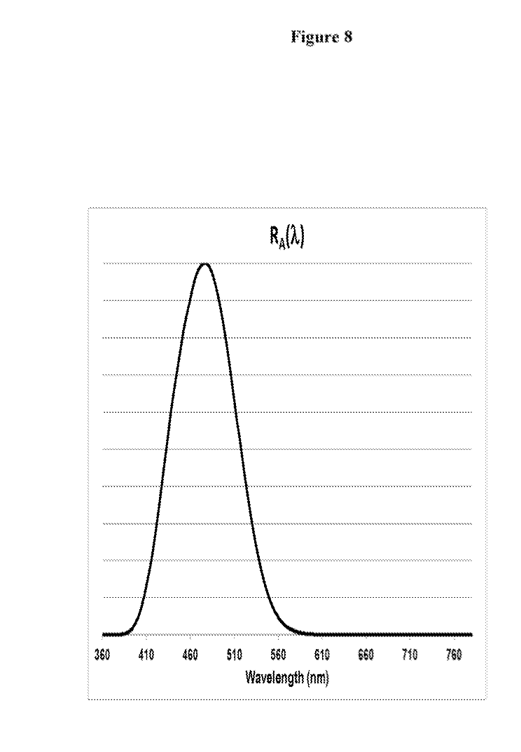

(5) An illustrative example ipRGC) spectral distribution function R_{A} (λ) is shown in FIG. 8. This function peaks at approximately 476 nm, and this position is illustrative of other functions which may peak at other wavelengths. As will be found by future research, arbitrary other functions can be employed based on the relations described herein. Additionally, an arbitrary distribution R_{A} (λ) might be multi-peaked or might consist of a linear or nonlinear combination of other arbitrary distributions. Additionally arbitrary distributions may be expressed in terms of units of energy or frequency instead of wavelength.

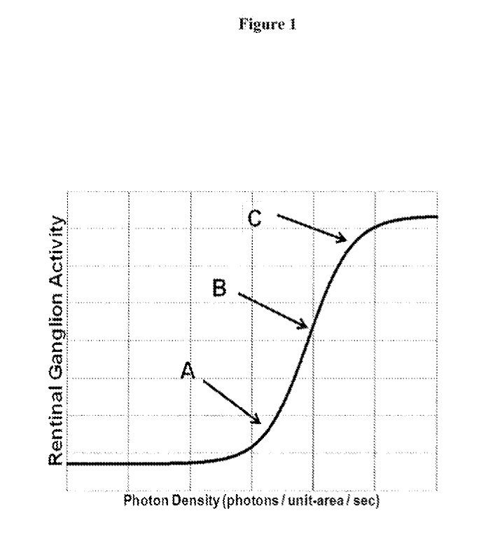

(6) Research protocols investigating ipRGC response typically present the data in the form of a univariant sigmoidal curve (see FIG. 1). Such curves may have three apparent inflection characteristics. Point A may be characterized by a peak in first derivative, and represents approximately a ‘turn-on’ point for RG activity, point B may be characterized by a peak/minimum in the second derivative and approximately represents a 50% activity level, while point C may be characterized by a peak, in the first derivative, and represents approximately the point before saturation of response is reached. Characterizations of the positions of points A, B, C based on derivative definitions is approximate, and depends on the functional form defined to represent the sigmoidal type activity. Some functional forms may not necessarily offer useful derivative criteria for selecting points A, B or C, and may need to be treated empirically or by best guess location of points A, B, and C. Additionally other points, anywhere along the curve, may be defined to represent a specific clinical response. Each of the identified critical points in units of photons/unit-area/sec can be converted to a power threshold of μW/cm2. These are designated P_{A}, P_{B}, P_{C} etc.

(7) A Trial filter is designated by a transmission spectrum T_{F} (λ). This may be the filter which adjusts the spectral distribution for a subject.

The illuminance, I (α), external to a subject wearing glasses (or shielded by the filter) is given by:

$$I ( α ) = α {\sum }_{λ = 360}^{λ = 830} S ( λ ) V ( λ ) Δ λ \qquad ( 1.1 )$$

Note in equation 1.1 that when α=1, this equation reverts to the standard calculation for illuminance. If the summation is in one nm steps, then Δλ=1 nm. Keeping in mind that α is an adjustable parameter, the power, within, the visible light regime, transmitted through the filter is given by:

$${P}^{T} = α {\sum }_{λ = 360 n m}^{λ = 830 n m} S ( λ ) {T}_{F} ( λ ) Δ λ \qquad ( 1.2 )$$

The total power in the visible, neglecting the filter is:

$${P}^{′} = α {\sum }_{λ = 360 n m}^{λ = 830 n m} S ( λ ) Δ λ \qquad ( 1.3 )$$

The effective power, as governed by an ipRGC response distribution function, transmitted through a filter is given by:

$${P}^{T , RG} = α {\sum }_{λ = 360 n m}^{λ = 830 n m} {R}_{A} ( λ ) S ( λ ) {T}_{F} ( λ ) Δ λ \qquad ( 1.4 )$$

### Optimization Process:

Typically, when optimizing an optical filter for a subject or group of subjects, the important parameters are the color rendering (CR), the transmitted luminosity (LT), and the amount of intervention necessary with regard to the ipRGC response. This fatter quantity is given by the P_{A}, P_{B}, P_{C}, etc. quantities defined above for a given region of the ipRGC response.

This intervention, modulation, or control is specified as a Lux limit for a certain ipRGC response for a specific set of illuminant spectral distributions.

For this optimization, all members of the set of transmission wavelengths, T_{P} (λ) (λ=360 nm, 361 nm, 362 nm, . . . etc.) are freely varied to achieve the optimal color rendering and transmission, while a is adjusted to assure that P^{T.RG}=P_{A} remains true, if the desired ipRGC response is condition A above. The equivalency condition, can be selected from among P^{T.RG}=P_{B}, P^{T.RG}=P_{C}, etc., varies as the need to adjust the ipRGC response for the subject.

The optimization methodology for CR and LT follows as in U.S. Pat. Nos. 7,663,739, 7,626,693 (each of which is hereby incorporated by reference in its entirety). As discussed in these documents, LT may be calculated either using the standard or modified photopic luminous efficiency function (as referred to above).

The adjustment of a to achieve one of the equivalency conditions (e.g.: P^{T.RG}=P_{A}) yields a net external illuminance threshold I(α) for that condition as specified in equation 1.1. Note that this is the lighting prior to passing through the filter the subject is wearing (or that is shielding or otherwise providing optical filtering for the subject). This represents a threshold external illuminance beyond which the RG response condition (e.g., if point A of FIG. 1, this would be the initiation of RG activity) will not necessarily be maintained.

In practice, using this approach, the subject's living and working environmental illuminances can be taken into account. For instance, if the subject's environmental illuminance is I_{S}, then one must assure that to control to a particular ipRGC response threshold, the I(α) specification for the glasses provided to the subject, remains above this value. In some aspects, the subjects living or working environmental illuminances are measured by a spectral irradiance meter. The spectral irradiance meter (e.g., portable) can be carried, by the subject throughout a typical day to measure the lighting environment and then based of this information the optimized filter can be appropriately specified by the optimization process described herein. The spectral irradiance meter can be configured to measure light at any wavelength or range of wavelengths. In a specific aspect, the wavelength or range of wavelengths is within the ipRGC response range. In some aspects, the spectral irradiance meter has a USB interface. For example such data may be recorded on a memory storage device such as a USB flash drive, SD card, mini-SD card, smartphone or similar portable electronic device. One such example of a spectral irradiance meter is the Konica/Minolta SpectraRad (made by B&W Tek Newark, Del.) although other appropriate meters can be used. Taking into account, color rendering (CR), luminous transmission (LT), and ipRGC response, one can optimize a variety of conditions, as necessary, including: optimal color rendering, optimal luminous transmission, and optimal ipRGC response.

The optimization is advantageously embodied in a computer product or software program or application that is configured to receive user input of 1, 2, 3, 4, 5, 6, or more variables related to the optimization process described above and then generate an optimized optical product.

The computer product, program, software or application has code to perform the following steps for generation of a filter or illuminant having an optimized- ipRGC response, color rendering and luminance transmission. Thus, the method comprises (1) obtaining a reference spectrum, (2) generating a trial spectrum, (2) calculating one or more optical indices of the trial spectrum relative to the reference spectrum, and (3) generating an optimized spectral profile by varying the trial spectrum to optimize the one or more optical indices of the trial spectrum relative to reference spectrum, wherein the one or more optical indices comprises calculating the reduction in radiance, irradiance, or radiant intensity within a specified spectral region for achieving a selected ipRGC response. In some aspects, the step of calculating the one or more optical indices comprises calculating the reduction in luminance for achieving a selected ipRGC response. The step of calculating one or more optical indices of the trial spectrum can comprise further calculating the CRI of the trial spectrum relative to the reference spectrum. In some aspects, the step of generating a trial spectrum can comprise varying the trial spectrum to maximize the reduction in luminance to achieve a selected ipRGC response (or alternatively minimizing the reduction in luminance required to achieve a selected ipRGC response) of the trial spectrum while simultaneously maximizing the CRI of the trial spectrum. In some aspects, the method can comprise selecting a target reduction in luminance for a selected ipRGC response of the trial spectrum (e.g., equal to, greater than, or between any of about 50%, 60%, 65%, 70%, 75%, 80%, 85%, 90%, 95%, or any other percentage between 5% and 100%); and varying the trial spectrum to maximize the CRI of the customized trial spectrum at the target reduction in luminance. In another aspect, the step of generating a trial spectrum can comprise selecting a target CRI (e.g., equal to, greater than, or between any of about: 40, 45, 50, 55, 60, 65, 70, 75, 80 85, 86, 87, 88, 89, 90, 91, 92, 93, 94, 95, 96, 97, 98, 99, or any other value between 50 and 100) of the trial spectrum; and varying the trial spectrum to maximize the reduction in luminance to achieve a selected ipRGC response (or alternatively minimizing the reduction in luminance required to achieve a selected ipRGC response) of the trial spectrum at the target CRI.

As described herein, an optical filter (e.g., ophthalmologic product) is provided having a balanced condition of selected levels of CR, LT and ipRGC. In accordance with these methods and products, a variety of embodiments are provided as described in more detail below:

In one embodiment an ophthalmologic product is provided having a selected ipRGC response, a selected CR and a selected LT. In one aspect of this embodiment, a plurality of ophthalmologic products is provided having a selected ipRGC response, a plurality of selected CR and a plurality of selected LT. Accordingly, the ipRGC response can be any selected ipRGC response. In some ophthalmologic products, the ipRGC response is less than the ipRGC initiation response (e.g., as indicated by point A of FIG. 1). In some ophthalmologic products, the ipRGC response corresponds approximately to the ipRGC initiation response. In some ophthalmologic products, the ipRGC response corresponds approximately to a response between initiation of ipRGC response and 50% ipRGC response (e.g., as indicated by point B of FIG. 1), in some ophthalmologic products, the ipRGC response corresponds approximately to a 50% ipRGC response. In some ophthalmologic products, the ipRGC response corresponds approximately to a 50% ipRGC response and saturation of ipRGC response (e.g., as indicated by point C of FIG. 1). In some ophthalmologic products, the ipRGC response corresponds approximately to the saturation of ipRGC response, in some ophthalmologic products, the ipRGC response is greater than the saturation of ipRGC response. The ipRGC response profile or value can be one selected to provide a therapeutic effect for a disease or condition where ipRGC modulation is desirable, e.g., expected to be therapeutic or prophylactic. In a specific aspect, the disease or condition where ipRGC is desirable is migraine, blepharospasm, traumatic-brain injury or a circadian patterning associated disorder

In one embodiment, an ophthalmologic product is provided having a selected. ipRGC response. Accordingly, the ophthalmologic product is selected to have an ipRGC response suitable for providing a therapeutic effect for the disease or condition where ipRGC modulation is desirable, therapeutic or prophylactic, in a specific aspect of this embodiment, the disease or condition is selected from migraine, blepharospasm, traumatic brain injury and a circadian patterning disorder. Once the suitable ipRGC response is known based on light sources that the individual is exposed to, CR and LT can be optimized to achieve this ipRGC response.

In one embodiment, a method for adjusting an ipRGC prescription for a patient or individual is provided. Accordingly, the method involves identifying a patient or individual in need of adjustment of an ipRGC prescription. Typically, such a patient or individual is not experiencing optimal therapeutic or prophylactic effects from their ipRGC prescription. The method of this embodiment comprises adjusting up or down the strength of the ipRGC prescription, for a patient. For example, a patient having or suffering from migraine headaches and using a selected ipRGC prescription is not experiencing relief of symptoms or adequate relief of symptoms. The ipRGC prescription is then adjusted (e.g., up or down) to improve therapy or prophylaxis of the migraines. For example, persons suffering from migraine headache or headache associated with TBI typically experience multiple episodes of severe head pain varying in frequency from several times a day to multiple times per month. These episodes can be triggered by different events and conditions, which can be different for each patient. Such conditions can include time of day, activity being pursued, chemical imbalances (including hormonal changes), foods eaten, stress, sounds or smells, medications, changes of weather, or changes in daily routine. Based on the frequency, severity, or cause of the headache, a prescription for a filter that blocks a selected range of the visual spectrum, with a selected percent blockage (reduction in luminance) of that wavelength range (e.g., 70% block, or 90% block) is provided for the individual or patient. The prescription can include guidelines for use of the filter so as to specify the length of time for which a filter should be worn or used and under what type of lighting conditions (sunlight, incandescent, fluorescent, etc.). Based on feedback from the patient as to the relative number and severity of subsequent headache episodes, the properties of the filter can be adjusted to minimize headaches. In one specific aspect, the percent blockage of light in the particular wavelength range is altered up or down (e.g., from 70% blockage in the old prescription altered to 90% blockage in the new prescription or 85% blockage in the old prescription altered to 70% blockage in the new prescription). In a particular aspect of this embodiment, the method involves a system, for reporting a symptoms or symptoms of the disease or condition that the ipRGC prescription, is being used for treatment or prophylaxis, in some aspects, the system can involve reporting the symptoms or symptoms by e.g., a computer, telephone or smartphone interface or application. In this way, an improvement or lack of improvement in the symptom or symptoms can be monitored and allow for or aid in determining whether or not an adjustment is desirable.

In another embodiment, an ophthalmologic product is provided based on a selected color rendering or luminous transmission while providing an optimal ipRGC response control for the individual. The optimal ipRGC response control can be a selected ipRGC response control. In some products the optimal ipRGC response control is an ipRGC response control that has a therapeutic or prophylactic effect for a disease or condition or where ipRGC response control is desirable. In one specific aspect, the disease or condition is migraine, blepharospasm, traumatic brain injury and a circadian patterning disorder.

In yet another embodiment, an ophthalmologic product is provided that is optimized, for an ipRGC response for a specific illumination. The ophthalmologic product is optimized for sunlight, incandescent, fluorescent, LEDs, or mixtures thereof.

By way of example, in contrast to the previous description of how persons suffering from migraine headache would be prescribed a filter product, another patient population include people suffering from disruptions of the circadian sleep/wake cycle (a circadian patterning disorder). There are many forms of sleep disorders; a specific example is Delayed Sleep Phase Disorder (DSPD). In this condition, the affected person is exposed to bright light in the evening, causing a delay in the time of sleep onset, poor sleep quality, and difficulty waking up in the morning, and subsequent poor alertness and task performance. In addition, the subject may have disrupted hormonal patterns, core body temperature, etc. This is a particular problem for school-age children who sit in front of a brightly-illuminated television or computer monitor late at night. Roughly half of diagnosed sufferers also display depression or other psychiatric manifestations. One exemplary manner of employing a treatment includes having a patient visit a sleep disorder clinic, provide a history, and spend a few nights while physiological data were collected. Based on the patient history and display of symptoms, a doctor would prescribe the use of glasses utilizing a specified filter, to be worn alter a certain time at night. This would allow the patient to pursue their normal routine, while blocking specific wavelengths of light that delay the onset of sleep. The net result is that the patient would feel sleepy at a normal bedtime, get a normal night's sleep and awaken at a normal time, in addition to prescribing glasses, the doctor may prescribe a thin-film coating containing a light filter layer that blocks specific wavelengths of light from activating the ipRGCs. This could be applied to a TV screen or computer monitor. In addition, a doctor could prescribe the use of light sources incorporating the necessary filter parameters so as to allow a person to work in an environment so illuminated, while allowing them to fall asleep at a normal time. Based on feedback from the patient as to the resultant changes in sleep patterns, a product, may be prescribed that alters the wavelengths of light filtered, the degree of blockage of those wavelengths, and the duration of use so as to achieve normalization of sleep patterns. Accordingly, a system for determining an ophthalmologic product for use in an individual experience a sleep disorder is provided. The system involves determining if an individual has a sleep disorder or a disruption in the circadian sleep/wake cycle that may be modulated by attenuating ipRGC response. Individuals having a sleep disorder or disruption in the circadian sleep/wake cycle are provided with an ophthalmologic product or an optical filter that improves the sleep disorder or disruption of the circadian sleep/wake cycle. As described, above the ophthalmologic product or an optical filter is chosen such that it blocks a selected percentage of a wavelength or range of wavelengths of light.

In contrast to the previous description of how filter products can be used to entrain or maintain an endogenous circadian rhythm, in another example, selective filters as applied to ophthalmologic products, a filtered light source, can be used to reset the circadian pacemaker, e.g., in instances where an individual is experiencing “jet lag” by changing time zones or makes a necessary adjustment from a nocturnal “night shift” schedule to a “day shift” diurnal biorhythm. Under these conditions the ipRGCs of the affected person are exposed to light at a time of day not corresponding to their intrinsic circadian rhythm, with resultant disruptions of

sleep patterns, body temperature, and hormonal release, as well as deficits of cognitive performance and alertness. To employ a treatment, a patient would visit a physician, who would prescribe the use of glasses utilizing a specified filter, to be worn so as to mimic the onset of night corresponding to the desired circadian rhythm. When so used, the person's body would adapt to the new environmental conditions as a signal indicating impending sleep onset, and they would fall asleep at a time appropriate to that, local environment. Once a night of normal sleep had been completed, the physiological state of the person would be largely reset, with respect to the central circadian pacemaker. In this way the person would be able to proceed with a normal routine, sleeping and awakening at appropriate times. In addition to prescribing glasses, a doctor might prescribe the use of light, sources incorporating the necessary filter parameters so as to allow a person to work in an environment so illuminated, adapting them to light conditions appropriate to the new location or desired diurnal/nocturnal schedule, while falling asleep and awakening at appropriate times. Based on feedback from the patient as to the effectiveness of resultant changes in circadian resetting, the product that is prescribed may be altered so as to change the wavelengths of light filtered, the degree of blockage of those wavelengths, and the duration of use so as to achieve desired circadian entrainment. Accordingly, a system for determining an ophthalmologic product for use In. resetting a person's circadian central pacemaker is provided. The system involves determining if an individual has a need to reset the internal circadian clock that may be modulated by attenuating ipRGC response. These individuals are provided with an ophthalmologic product or an optical filter that resets the central circadian pacemaker. As described above, the ophthalmologic product or optical filter is chosen such that it blocks a selected percentage of a wavelength or range of wavelengths of light.

Another embodiment is related to circumstances of no filter or no protective glasses being provided. Under these circumstances the illuminant spectral profile is varied to achieve optimal CR, luminance and ipRGC response. This is illustrated by, but not limited to, the example data provided in Table 11. Different illuminants demonstrate different ipRGC clinical thresholds. In tins embodiment of the invention members of the set S(λ) are varied to achieve optimal CR and ipRGC thresholds. This new illuminant, representing an embodiment of the invention, can then be a clinical specification (e.g., ipRGC response control) provided for a subject or group of subjects.

Illuminants may include any optical filter or filters, and any illuminant capable of effecting the ipRGC response. Illuminants, in some embodiments, can include an optical filter or lifters placed on windows to control external lighting.

Illuminants, in some embodiments, can include an optical filter or filters used with other artificial or natural illuminants.

The illuminant, in some embodiments, can include a spectral array of illuminants of different colors which are adjusted as necessary to achieve the specifications provided by methods described herein.

The illuminant, in some embodiments, can include an incandescent illuminant.

The illuminant, in some embodiments, can include a fluorescent illuminant.

The illuminant, in some embodiments, can include a light emitting diode (LED) or array of light emitting diodes. Alternatively, the illuminant can be an organic LED or OLED.

The illuminant, in some embodiments, can include a laser diode (LD) or array of laser diodes, or any other laser device or array thereof.

The illuminant, in some embodiments, can include any diffuse or specular reflection device coupled with any source of light.

The illuminant, in some embodiments, can include a combination of any other illuminants specified under this invention.

The illuminant, in some embodiments, can include abroad area illuminant, full room illuminant, partial room illuminant, or spot or localized illuminant.

The illuminant, in some embodiments, can include display device such as a CRT, LCD, plasma, or any display mechanism involving other illuminants specified under this invention. An illustrative, but not limiting example might be for instance a computer display screen or television screen

The illuminant, in some embodiments, can include an illuminant that is projected onto a typical reflection display screen as seen in movie theatres and classrooms. In this case the illuminant is both that which imparts light onto the display screen or use of the reflective properties of the screen itself, in which the screen itself is defined, as an illuminant.

In some implementations, the illuminant can be a combination of the use of an ophthalmic product as described herein, in combination with use of an illuminant as described herein.

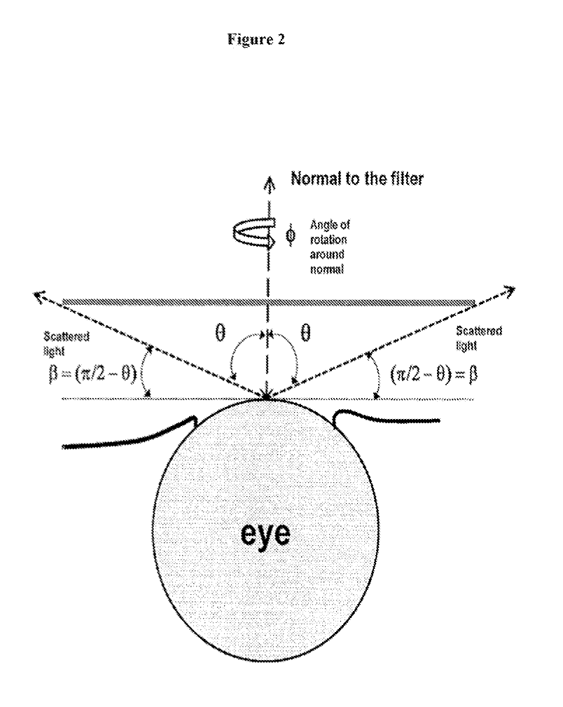

The circumstance arises that some light can scatter around the side a subject's glasses. This can affect the performance of the system, and the methods and products described herein can correct and account for this in the optimizations described above. In a specific implementation, this can be accomplished by assuming the eye is a Lambertian detector, and that light which propagates into the eye close to the normal of the filter will hold more of the power than light which propagates in along an extreme angle (from the filter normal) from the side of the eye. See FIG. 2.

As given by FIG. 2, and assuming a Lambertian cosine law, and neglecting the presence of a filter, so that θ runs from 0 to π/2, the total light power entering the eye is given by:

$${I}_{eye} = {P}^{′} {\int }_{0}^{π / 2} {\int }_{0}^{2 π} cos ( θ ) sin ( θ ) d φ d θ = π {P}^{′} \qquad ( 1.5 )$$

If a filter is present, then an approximately cylindrical opening exists for light to enter at angles greater then θ without passing through the filter. This angle β then controls the intensity of the scattered light which enters without being filtered. This scattered light power is given by;

$${I}_{sc} = {P}^{′} {\int }_{π / 2 - β}^{π / 2} {\int }_{0}^{2 π} cos ( θ ) sin ( θ ) d φ d θ \qquad ( 1.6 )$$

If we presume β=18° (0.1 π radians), then the scattered power entering the eye is ˜0.0955πP′. The ratio of equations 1.6 and 1.5 (X=Iₛₑₐ/I_{eye}) provides the fraction of power

entering the eye as scattered light (without passing through the filter), and for this trial example X is 9.55%. Note that X can also easily be determined by experimental procedures.

One can then optimize a filter to an ipRGC response condition, taking into consideration the scattering (not through the filter) contribution, by, for instance, forcing the following equation to be true by adjusting a in the filter optimization process:

XP′+(1−X) P^{T.RG}=P_{A} (1.7)

In this case the permitted luminous intensity for the environment may be smaller because some of the light is entering the eye unfiltered. This remarkable finding derived from these observations may provide for optimized filters that prevent stray light or scattered light from undesirably altering an ipRGC response.

Thus, in some embodiments, the ophthalmologic product fits flush to the face in a wrap-around type configuration to provide a selected or desired ipRGC response.

In other embodiments, the ophthalmologic product is configured to block some of the light entering from the left and right side by having a light blocking baffle to provide a selected or desired ipRGC response.

In some embodiments, the x for an ophthalmologic product is considered when optimizing the ipRGC of the filter. To achieve certain levels of ipRGC response control it may be desirable to have either a wrap-around flush to face design or a light blocking baffle. In some aspects of the optimization methods and systems for identifying or providing filters with an optimized ipRGC response control comprise estimating X or measuring X using a cosine detector. In some embodiments, the ophthalmologic product provides an ipRGC response suitable for a condition or disease that can be treated or prevented by modulation of ipRGC response. In some aspects, the range (notch) for ipRGC response control can be a total of 20, 25, 30, 35, 40, 45, 50, 55, 60, 65, 70, 75 or more am wide (can be one contiguous band or two, three, four, or five or more noncontiguous bands (e.g., 2 notches, 3, notches, 4 notches or 5 notches or more)), centered at 460, 465, 470, 475, 480, 485, 490, 495, 500, 505, 510, or 515_nm. Under these conditions, this filter blocks 10%, 20%, 30%, 40%, 50%, 60%, 70%, 80%, 90% or 95% or more of light constituting the ipRGC response range. In some aspects, the optical filter selectively blocks desired wavelengths for modulating ipRGC response and does not substantially block light transmission below 450 nm, 445 nm, 440 nm, 435 nm or 430 nm (e.g., blocks less than 20%, 15%, 10% or 5% of light in this range). The color rendering of the optical filter can be greater than 10, 30, 50, 70, 75, 80, 85, or 90 in reference to CRM09. The color rendering can be determined based on a selected illuminant. Accordingly, the optical filter can be configured, to transmit at least some portion of light having a wavelength above about 400 nanometers (nm) and to substantially block light having a wavelength below about 400 nm. In another configuration, the optical filter is configured to transmit at least some portion of light having a wavelength below about 750 nanometers (nm) and to substantially block light having a wavelength, above about 750 nm. In some aspects of this embodiment, the optical filter is configured to: (a) block at least 95% of light having a wavelength below about 410 nanometers; (b) block at least 95% of light having a wavelength, above about 710 nm; (c) block between about 70% and about 90% light having a wavelength between about 510 nm and about 550 nm and between about 590 nm and about 630 nm: and (d) block less than about 20% of at least one wavelength of light having a wavelength between about 450 nm and about 470 nm. In other aspects of this embodiment, the optical filter is configured, to block at least 95% of at least one wavelength of light having a wavelength between about 460 nm and about 490 nm. In some implementations, the optical filter is configured to transmit between about 20% and about 30% of at least one wavelength of light having a wavelength between about 520 nm and about 540 nm. In some aspects, the optical filter is configured to block between about 85% and about 95% of at least one wavelength of Sight having a wavelength between about 560 nm and about 580 nm. In other aspects, the optical -filter is configured to transmit between about 15% and about 25% of at least one wavelength of light having a wavelength between about 600 nm and about 620 nm. In some aspects of this embodiment, the optical filter is configured to: (a) block between about 70% and 90% or more of light having a wavelength between about 460 nm and 490 nm; (b) block less than about 20% of light having a wavelength below about 445 nm: and (c) block less than about 20% of light having a wavelength above about 520 nm. The optical filter can be any optical filter that filters light that is exposed to an individual. In some aspects, the optical filter is an eyewear lens or lenses, part of an eyewear system, flip-up, goggle, window, windshield, television screen, or computer screen.

In some embodiments, the ophthalmologic product provides an ipRGC response suitable for treating or preventing a migraine or migraines. In some aspects, the range (notch) for ipRGC response control, can be a total of 20, 25, 30, 35, 40, 45, 50, 55, 60, 65, 70, 75 or more am wide (can be one contiguous band or two, three, four, or five or more noncontiguous bands (e.g., 2 notches, 3, notches, 4 notches or 5 notches or more)), centered at 460, 465, 470, 475, 480, 485, 490, 495, 500, 505, 510, or 515_nm. Under these conditions, this filter blocks 10%, 20%, 30%, 40%, 50%, 60%, 70%, 80%, 90% or 95% or more of light constituting the ipRGC response range. In some aspects, the optical filter selectively blocks desired wavelengths for modulating ipRGC response and does not substantially block light transmission below 450 nm, 445 nm, 440 nm, 435 nm or 430 nm (e.g., blocks less than 20%, 1.5%, 10% or 5% of light in this range). The color rendering of the optical filter can be greater than 10, 30, 50, 70, 75, 80, 85, or 90 in reference to CRI-109. The color rendering can be determined based on a selected illuminant. Accordingly, the optical filter can be configured to transmit at least some portion of light having a wavelength above about 400 nanometers (nm) and to substantially block light having a wavelength below about 400 nm. In another configuration, the optical filter is configured to transmit at least some portion of light having a wavelength below about 750 nanometers (nm) and to substantially block light having a wavelength above about 750 nm. In some aspects of this embodiment, the optical filter is configured to: (a) block at least 95% of light having a wavelength below about 410 nanometers; (b) block at least 95% of light having a wavelength above about 710 nm; (c) block between about 70% and about 90% light having & wavelength between about 510 nm and about 550 nm and between about 590 nm and about 630 nm; and (d) block less than about 20% of at least one wavelength of light having a wavelength between about 450 nm and about 470 nm. In other aspects of this embodiment, the optical filter is configured to block at least 95% of at least one wavelength of light having a wavelength between about 460 nm and about 490 nm. In some implementations, the optical filter is configured to transmit between about 20% and about 30% of at least one wavelength of light having a wavelength between about 520 nm and about 540 mm. In some aspects, the optical filter is configured to block between about 85% and about 95% of at least one wavelength of light having a wavelength between about 560 nm and about 580 nm. In other aspects, the optical filter is configured to transmit between about 15% and about 25% of at least one wavelength of light having a wavelength between about 600 nm and about 620 nm. In some aspects of this embodiment, the optical filter is configured to: (a) block between about 70% and 90% or more of light having a wavelength between about 460 nm and 490 nm; (b) block less than about 20% of light having a wavelength below about 445 nm; and (c) block less than about 20% of light having a wavelength above about 520 nm. The optical filter can be any optical filter that filters light that, is exposed to an individual. In some aspects, the optical filter is an eyewear lens or lenses, part of an eyewear system, flip-up, goggle, window, windshield, television screen or computer screen.

In some embodiments, the ophthalmologic product provides an ipRGC response suitable for treating or preventing blepharospasm. In some aspects, the range (notch) for ipRGC response control can be a total of 20, 25, 30, 35, 40, 45, 50, 55, 60, 65, 70, 75 or more nm wide (can be one contiguous band or two, three, four, or five or more noncontiguous bands (e.g., 2 notches, 3, notches, 4 notches or 5 notches or more)), centered at 460, 465, 470, 475, 480, 485, 490, 495, 500, 505, 510, or 515 nm. Under these conditions, this filter blocks 10%, 20%, 30%, 40%, 50%, 60%, 70%, 80%, 90% or 95% or more of light constituting the ipRGC response range. . In some aspects, the optical filter selectively blocks desired wavelengths for modulating ipRGC response and does not substantially block light transmission below 450 nm, 445 nm, 440 nm, 435 nm or 430 nm (e.g., blocks less than 20%, 15%, 10% or 5% of light in this range). The color rendering of the optical filter can be greater than 10, 30, 50, 70, 75, 80, 85, or 90 in reference to CRI-109. The color rendering can be determined based on a selected illuminant. In. some embodiments, the optical filter is configured to transmit at least some portion of light having a wavelength above about 400 nanometers (nm) and to substantially block light having a wavelength below about 400 nm. In some embodiments, the optical filter is configured to transmit at least some portion of light having a wavelength below about 750 nanometers (nm) and to substantially block light having a wavelength above about 750 nm. In some embodiments, the optical filter is configured to: (a) block at least 95% of light having a wavelength below about 410 nanometers; (b) block at least 95% of light having a wavelength above about 710 nm; (c) block between about 70% and about 90% light having a wavelength between about 510 nm and about 550 nm and between about 590 nm and about 630 nm; and (d) block, less than about 20% of at least one wavelength of light having a wavelength between about 450 nm and about 470 nm. In some embodiments, the optical filter is configured to block at least 95% of at least one wavelength of light having a wavelength between about 460 nm and about 490 nm. In some embodiments, the optical filter is configured to transmit between about 20% and about 30% of at least one wavelength of light having a wavelength between about 520 nm and about 540 mm. in some embodiments, the optical filter is configured to block between about 85% and about 95% of at least one wavelength, of light having a wavelength between about 560 nm and about 580 nm in some embodiments, the optical filter is configured to transmit between about 15% and about 25% of at least one wavelength of Sight having a wavelength between about 600 nm and about 620 nm. In some aspects of this embodiment, the optical filter is configured to; (a) block between about 70% and 90% or more of light having a wavelength between about 460 nm and 490 nm; (b) block less than about 20% of light having a wavelength below about 445 nm; and (c) block, less than about 20% of light having a wavelength above about 520 nm. The optical filter can be any optical filter that filters light that is exposed to an individual. In some aspects, the optical, filter is an eye glass lens or lenses, part of an eyewear system, flip-up, goggle, window, windshield, television screen or computer screen.

In some embodiments, the ophthalmologic product provides an ipRGC response suitable for treating traumatic brain injury or preventing symptoms thereof. In some aspects, the range (notch) for ipRGC response control can be a total of 20, 25, 30, 35, 40, 45, 50, 55, 60, 65, 70, 75 or more nm wide (can be one contiguous band or two, three, four, or five or more noncontiguous bands (e.g., 2 notches, 3, notches, 4 notches or 5 notches or more)), centered, at 460, 465, 470, 475, 480, 485, 490, 495, 500, 505, 510, or 515 nm. Under these conditions, this filter blocks 10%, 20%, 30%, 40%, 50%, 60%, 70%, 80%, 90% or 95% or more of light constituting the ipRGC response range. In some aspects, the optical filter selectively blocks desired wavelengths for modulating ipRGC response and does not substantially block light transmission below 450 nm, 445 nm, 440 nm, 435 nm or 430 nm (e.g., blocks less than 20%, 15%, 10% or 5% of light in this range). The color rendering of the optical filter can be greater than 10, 30, 50, 70, 75, 80, 85, or 90 in reference to CRT 109, The color rendering can be determined based on a selected illuminant. In some embodiments, the optical filter is configured to transmit at least some portion of light having a wavelength above about 400 nanometers (nm) and to substantially block light having a wavelength below about 400 nm. In some embodiments, the optical filter is configured to transmit at least some portion of light having a wavelength below about 750 nanometers (nm) and to substantially block light, having a wavelength above about 750 nm. In some embodiments, the optical filter is configured, to; (a) block at least 95% of light having a wavelength below about 410 nanometers; (b) block at least 95% of light having a wavelength above about 710 nm; (c) block between about 70% and about 90% light having a wavelength between about 510 nm and about 550 nm and between about 590 nm and about 630 nm; and (d) block less than about 20% of at least one wavelength of light having a wavelength between about 450 nm and about 470 nm. In some embodiments, the optical filter is configured to block at least 95% of at least one wavelength of light having a wavelength between about 460 nm and about 490 nm. In some embodiments, the optical filter is configured to transmit between about 20% and about 30% of at least one wavelength of light having a wavelength between about 520 nm and about 540 mm. In some embodiments, the optical filter is configured to block between about 85% and about 95% of at least one wavelength of light having a wavelength between about 560 nm and about 580 nm. In some embodiments, the optical filter is configured to transmit between about 15% and about 25% of at least one wavelength of light having a wavelength, between about 600 nm and about 620 nm. In some aspects of this embodiment, the optical filter is configured to: (a) block, between about 70% and 90% or more of light having a wavelength between about 460 nm and 490 nm; (h) block less than about 20% of light having a wavelength below about 445 nm; and (c) block less than about 20% of light having a wavelength above about 520 nm. The optical filter can be any optical filter that filters light that is exposed to an individual. In some aspects, the optical filter is an eye glass lens or lenses, part of an eyewear system, flip-up, goggle, window, windshield, or electronic display (e.g., computer or television screen),

In some embodiments, the ophthalmologic product provides an ipRGC response suitable for a circadian patterning disorder (e.g., entraining or maintaining circadian sleep/wake cycles or treating or presenting a disease or condition related to disruption of circadian sleep/wake cycle). In some aspects, the range (notch) for ipRGC response control can be a total of 20, 25, 30, 35, 40, 45, 50, 55, 60, 65, 70,75 or more nm wide (can be one contiguous band or two, three, four, or five or more noncontiguous bands (e.g., 2 notches, 3, notches, 4 notches or 5 notches or more)), centered, at 460, 465, 470, 475, 480, 485, 490, 495, 500, 505, 510, or 515 nm. Under these conditions, this filter blocks 10%, 20%, 30%, 40%, 50%, 60%, 70%, 80%, 90% or 95% or more of light constituting the ipRGC response range. In some aspects, the optical filter selectively blocks desired wavelengths for modulating ipRGC response and does not substantially block light transmission below 450 nm, 445 nm, 440 nm, 435 nm or 430 nm (e.g., blocks less than 20%, 15%, 10% or 5% of light in this range). The color rendering of the optical filter can be greater than 10, 30, 50,70, 75, 80, 85, or 90 in reference to CRM09. The color rendering can be determined based on a selected illuminant. In some aspects of this embodiment, the optical filter is configured to transmit at least some portion of light having a wavelength above about 400 nanometers (nm) and to substantially block light having a wavelength below about 400 nm. in some embodiments, the optical filter is configured to transmit at least some portion of light having a wavelength below about 750 nanometers (nm) and to substantially block light having a wavelength above about 750 nm. In some embodiments, the optical filter is configured to: (a) block at least 95% of light having a wavelength below about 410 nanometers; (b) block at least 95% of light having a wavelength above about 710 nm; (c) block between about 70% and about 90% light having a wavelength between about 510 nm and about 550 nm and between about 590 nm and about 630 nm; and (d) block less than about 20% of at least one wavelength of light having a wavelength between about 450 nm and about 470 nm. In some embodiments, the optical filler is configured to block at least 95% of at least, one wavelength of light having a wavelength between about 460 nm and about 490 nm. In some embodiments, the optical filter Is configured to transmit between about 20% and about 30% of at least one wavelength of light having a wavelength between about 520 nm and about 540 nm. In some embodiments, the optical filter is configured to block between about 85% and about 95% of at least one wavelength of light having a wavelength between about 560 nm and about 580 nm. In some embodiments, the optical filter is configured to transmit between about 15% and about 25% of at least one wavelength of light having a wavelength between about 600 nm and about 620 nm. In some aspects of this embodiment, the optical filter is configured to: (a) block between about 70% and 90% or more of light having a wavelength between about 460 nm and 490 nm; (b) block less than about 20% of light having a wavelength below about 445 nm; and (c) block less than about 20% of light having a wavelength above about 520 nm. The optical filter can be any optical filter that filters light that is exposed to an individual. In particular embodiments, the optical filter is an eyewear lens or lenses, part of an eyewear system, flip-up, goggle, window, windshield, or electronic display (e.g., television screen or computer screen).

Some embodiments of the present ophthalmologic products comprise optical filters (e.g., lenses) that are configured to be coupled to a sunglass frame or arty other eyewear frame (e.g., prescription or non-prescription glasses).

Embodiments of the optical filters disclosed herein can comprise any suitable materials that yield the optimized filter. Non-limiting examples of suitable materials include organic, inorganic, polymeric or a composite (e.g., combination) thereof Once the filters specifications are optimized as described herein (e.g., for an ipRGC response, CT, LT, and/or other optical indices), the skilled artisan is capable of selecting materials for the filter and manufacturing the filter. For example, a filter can comprise a substrate including glass (e.g., borosilicate glass), polycarbonate, plastic, polymer, etc. An example of a suitable substrate fat least for certain filter layer materials is 8511 Glass manufactured by Coming Corporation, U.S.A. In some embodiments, the substrate (e.g., 8511 Glass) is configured to transmit light having a wavelength above about 400 nanometers (nm) and to substantially block light having a wavelength below about 400 nm. By way of further examples, filter layers coupled to the substrate can comprise Niobium (Nb), such as, for example. Niobium Pentoxide (Nb₂O₅); and/or comprise Silicon (Si), such as, for example, Silicon Oxide (SiO₂). Other substrates can include tantalum (e.g., tantalum oxides).

In some embodiments, the ophthalmic product can have an anti-scratch coating, anti-fog coating, or UV coating or other coating to improve the performance of the product.

A method of manufacturing an object (e.g., ophthalmologic product) for modulation of light for treating or preventing, a disease or condition that can be treated or prevented by modulation of ipRGC response, or is expected to be treated or prevented by modulation of ipRGC response (e.g., migraine, blepharospasm, traumatic brain injury, or a circadian patterning disorder), is provided herein, said method comprising: identifying an individual in need of an object of light modulation for treating or preventing a disease or condition that can be treated or prevented by modulation of ipRGC response or is expected to be treated or prevented by modulation of ipRGC response (e.g., migraine, blepharospasm, traumatic brain injury, or a circadian patterning disorder); determining the light environment of the individual; selecting a filter for modulation of light; and manufacturing the object for modulation of light for treating or preventing a disease or condition that can be treated or prevented by modulation of ipRGC response or is expected to be treated or prevented by modulation of ipRGC response (e.g., migraine, blepharospasm, traumatic brain injury, or a circadian patterning disorder).

A method of manufacturing an optical filter (e.g., ophthalmologic product) is provided herein said method comprising: (1) optimizing color rendering of a filter: (2) optimizing the transmitted illuminance of the filter; (3) selecting the performance of the filter to provide improved control of ipRGC for a disease or condition selected from., migraine, blepharospasm, traumatic brain injury, or a circadian patterning disorder; and manufacturing the optical filter based on (1), (2), and (3). The manufacturing of an optimal filter comprises the optimization process as described herein.

In some embodiments, a computer program product embodied on a non-transitory computer readable medium is provided said product comprising computer code for: (1) receiving a selected color rendering; (3) receiving a transmitted luminance; (3) receiving a desired ipRGC activity modulation for a disease or condition selected from migraine, blepharospasm, traumatic brain injury, or a circadian patterning disorder and (4) determining a filter or specifications for a filter based on (1), (2), and (3). The determination comprises the optimization process as described herein.

In one embodiment, a process for optimizing a light filter for a subject is provided said process comprising: determining or providing a desired level of ipRGC attenuation for the subject for a disease or condition selected from migraine, blepharospasm, traumatic brain injury, or a circadian patterning disorder; determining the nature of lighting that the subject is exposed to; correcting for scattered light that does not enter through the filter; and manufacturing the optimized light filter. The optimization comprises the optimization process described herein.

In another embodiment, an optimized light filter comprising: a material having an optimized combination of color rendering and transmitted luminosity that provides a desired amount of ipRGC activity modulation for a disease or condition selected from migraine, blepharospasm, traumatic brain injury, or a circadian patterning disorder. The optimizing comprising the optimization process described herein.

In another embodiment, a method of optimizing a light filter for a subject or group of subjects is provided and includes:
(1) selecting or determining a color rendering;
(2) selecting or determining a transmitted luminosity; and
(3) selecting or determining an amount: of ipRGC intervention for a disease or condition, selected from conditions including migraine, blepharospasm, traumatic brain injury, or a circadian patterning disorder, and optimizing a light filter based on the selected or determining color rendering, transmitted luminosity and ipRGC intervention using the optimization process described herein

In an additional embodiment, a method of manufacturing a plurality of filters having a desired ipRGC activation profile is also provided and includes the steps of:
(1) selecting a desired ipRGC profile;
(2) determining a plurality values for color rendering and luminance transmission that achieve the desired ipRGC activation profile; and
(3) manufacturing a plurality of filters having a desired ipRGC activation profile based on the plurality of values for color rendering and luminance transmission that achieve the desired ipRGC activation profile using the optimization process described herein.

Another embodiment includes a system for modulating ipRGC activity by:
(1) determining a desired or optimized ipRGC activity;
(2) determining or optimizing color rendering;
(3) determining or optimizing a transmitted illuminance; and
(4) providing a filter for modulating ipRGC activity based on (1), (2), and (3) using the optimization process described herein.

An illustrative system for providing a filter or specification of a filter for modulating ipRGC activity is also provided and includes the steps of:
(1) receiving a desired ipRGC activity;
(2) providing a matrix of color rendering and transmitted illuminance values that can achieve a desired ipRGC activity;
(3) electing a combination of color rendering and transmitted illuminance that can achieve a desired ipRGC activity from the matrix provided in step (2); and
(4) providing a filter or the specifications of a filter for modulating ipRGC activity using the optimization process described herein.

### EXAMPLES

The following examples are included to demonstrate particular embodiments of the

invention. It should be appreciated by those of skill in the art that the techniques disclosed in the examples which follow represent techniques discovered by the inventors to function well in foe practice of the invention, and thus can be considered, to constitute particular modes for its practice. However, those of skill in the art should, in light of the present disclosure, appreciate that many changes can be made in the specific embodiments which are disclosed and still obtain a like or similar result without departing from the spirit and scope of the invention.

Illustrative examples of optimized filters along with parameters are provided. For the calculations below, the presumed RG initiation onset (point A of FIG. 1) is at 4 μW/cm², the 50% level (point B of FIG. 1) is at 5.5 μW/cm² and the onset of saturation (point C of FIG. 1) is at 18 μW/cm². These onset values are for illustrative purposes only, and not meant to be limiting or absolute specifications,

Color rendering characteristics of examples are provided in Table 12. A brief discussion of the examples follows. Note that some characteristics are sampled for discussion and that no effort is made to be thorough in characterizing all of the benefits and properties of all filters.

### Example 1

Example 1 is characteristic of a filter which displays a high degree of ipRGC attenuation. In incandescent (Standard illuminant A; not to be confused this with region “A” of FIG. 1) light, ipRGC effects are hilly attenuated up to 625 Lux, are fully attenuated up to 256 Lux under fluorescent light (F7), and fully attenuated up to 278 Lux in sunlight (D65). However, full saturation of ipRGC effects does not appear to be reached until a very high level of 1250-28.13 Lux, depending on illumination spectral distribution. It appears one can easily optimize to higher levels of protection using the methods described herein.

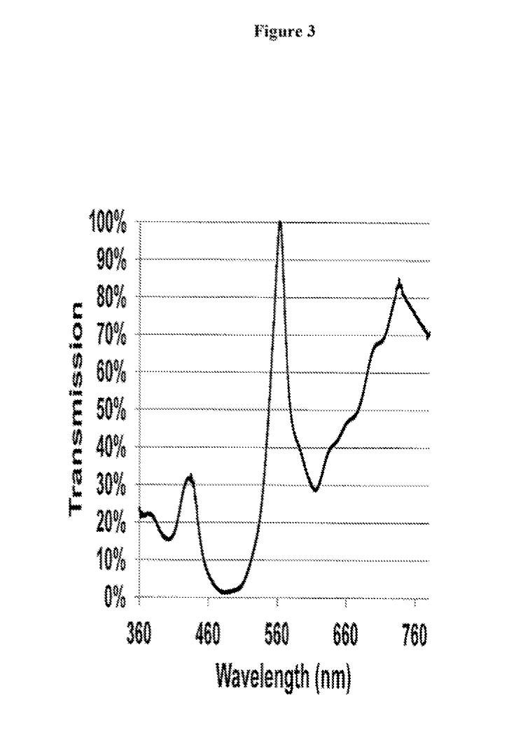

Table 1 illustrates the Example 1 ipRGC response Lux limits assuming no stray light (X=0) from sides. This data is also illustrated in FIG. 3.

ipRGC distribution function: R_{A} (λ)

| | Thresholds: μW/cm² | | |
|---|---|---|---|
| | Onset | 50% | saturation |
| | threshold; | threshold; | threshold; |
| | (Point A of | (Point B of | (Point C of |
| | FIG. 1) | FIG. 1) | FIG. 1) |
| | 4 | 5.5 | 18 |
| Lux @ | 625 | 859.5 | 2813 |
| Standard | | | |
| illuminant A | | | |
| Lux @ | 256 | 351 | 1149 |
| Standard | | | |
| illuminant F7 | | | |
| Lux @ | 278 | 382 | 1250 |
| Standard | | | |
| illuminant | | | |
| D65 | | | |

Table 2 illustrates the Example 1 ipRGC response Lux limits assuming x˜9.55% stray light from sides. This data, is also illustrated in FIG. 3.

ipRGC distribution function: R_{A} (λ)

| | Thresholds: μW/cm² | | |
|---|---|---|---|
| | Onset | 50% | saturation |
| | threshold; | threshold; | threshold; |
| | (Point A of | (Point B of | (Point C of |
| | FIG. 1) | FIG. 1) | FIG. 1) |
| | 4 | 5.5 | 18 |
| Lux @ | 358 | 492 | 1610 |
| Standard | | | |
| illuminant A | | | |
| Lux @ | 156 | 214 | 698 |
| Standard | | | |
| illuminant F7 | | | |
| Lux @ | 157 | 216 | 706 |
| Standard | | | |
| illuminant | | | |
| D65 | | | |

Example 1 indicates that scattered light may significantly reduce the effectiveness indicating that a wrap-around design may be desirable if high levels of ipRGC attenuation are required.

### Example 2

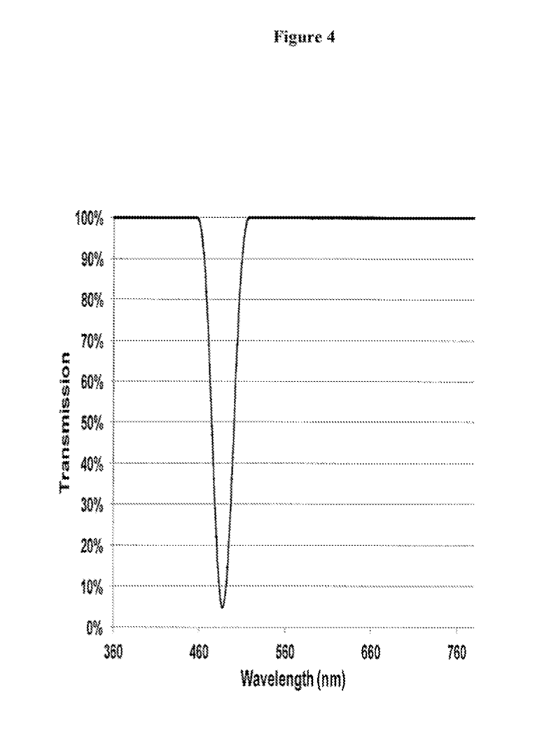

Example 2 illustrates a high attenuation filter in the region of ipRGC activity. It appears to possess a pale pink or orange color and to have high luminous transmission and good color rendering, it also appears to possess relatively low levels of ipRGC attenuation except at low light levels. Example 2 may be effective if hill saturation of an ipRGC response needs to be limited in light levels less than 189-200 Lux for fluorescent and sunlight. For all ipRGC levels of response, Example 2 may be adequate in incandescent lighting to levels as high as 100 Lux. Note by comparing data in Table 3 and Table 4 that it appears to be relatively unaffected by scattered light. This data is also illustrated in FIG. 4.

TABLE 3
Example 2 illustrates the ipRGC response Lux limits assuming no
stray light (χ = 0) from sides. This is also illustrated in FIG. 4.
ipRGC distribution function: R_{A} (λ)

| | Thresholds: μW/cm² | | |
|---|---|---|---|
| | Onset | 50% | saturation |
| | threshold; | threshold; | threshold; |
| | (Point A of | (Point B of | (Point C of |
| | FIG. 1) | FIG. 1) | FIG. 1) |
| | 4 | 5.5 | 18 |
| Lux @ | 100 | 137 | 449 |
| Standard | | | |
| illuminant A | | | |
| Lux @ | 45 | 61 | 200 |
| Standard | | | |
| illuminant F7 | | | |
| Lux @ | 42 | 58 | 189 |
| Standard | | | |
| illuminant | | | |
| D65 | | | |

TABLE 4
Example 2 illustrates the ipRGC response Lux limits assuming
χ ≈ 9.55% stray light from sides. This is also illustrated in FIG. 4.
ipRGC distribution function: R_{A} (λ)

| | Thresholds: μW/cm² | | |
|---|---|---|---|
| | Onset | | |
| | threshold; | | |
| | (Point A of | (Point B of | (Point C of |
| | FIG. 1) | FIG. 1) | FIG. 1) |
| | 4 | 5.5 | 18 |
| Lux @ | 97 | 133 | 433 |
| Standard | | | |
| illuminant A | | | |
| Lux @ | 43 | 59 | 194 |
| Standard | | | |
| illuminant F7 | | | |
| Lux @ | 41 | 56 | 183 |
| Standard | | | |
| illuminant | | | |
| D65 | | | |

### Examples 3-5

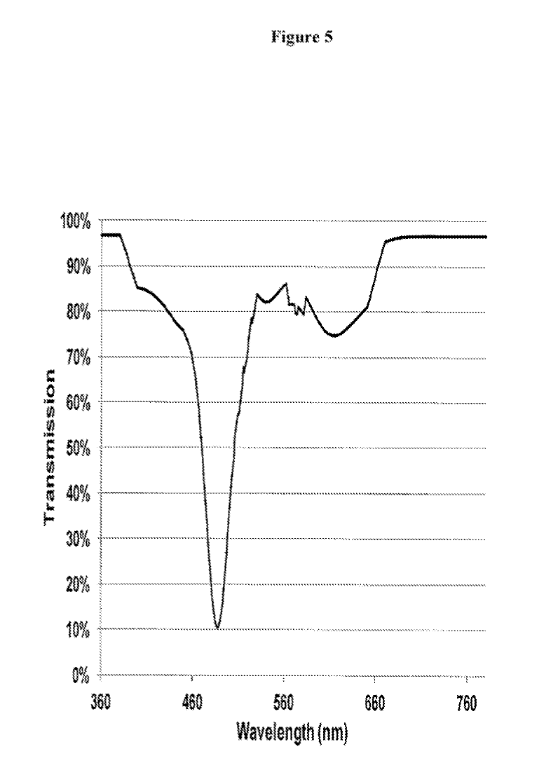

Examples 3-5 (FIGS. 5-7, respectively) illustrate a trend that appears to systematically improve ipRGC response protection while maintaining color rendering. These filters progressively become grayer, maintaining reasonably good color rendering, but also appear to significantly improve ipRGC protection at each version from Example 3 to Example 5.

TABLE 5
Example 3 illustrates the ipRGC response Lux limits assuming no stray
light (χ = 0) from sides. This data is also illustrated in FIG. 5.
ipRGC distribution function: R_{A} (λ)

| | Thresholds: μW/cm² | | |
|---|---|---|---|
| | Onset | 50% | saturation |
| | threshold; | threshold; | threshold; |
| | (Point A of | (Point B of | (Point C of |
| | FIG. 1) | FIG. 1) | FIG. 1) |
| | 4 | 5.5 | 18 |
| Lux @ | 131 | 180 | 588 |
| Standard | | | |
| illuminant A | | | |
| Lux @ | 58 | 80 | 260 |
| Standard | | | |
| illuminant F7 | | | |
| Lux @ | 55 | 76 | 248 |
| Standard | | | |
| illuminant | | | |
| D65 | | | |

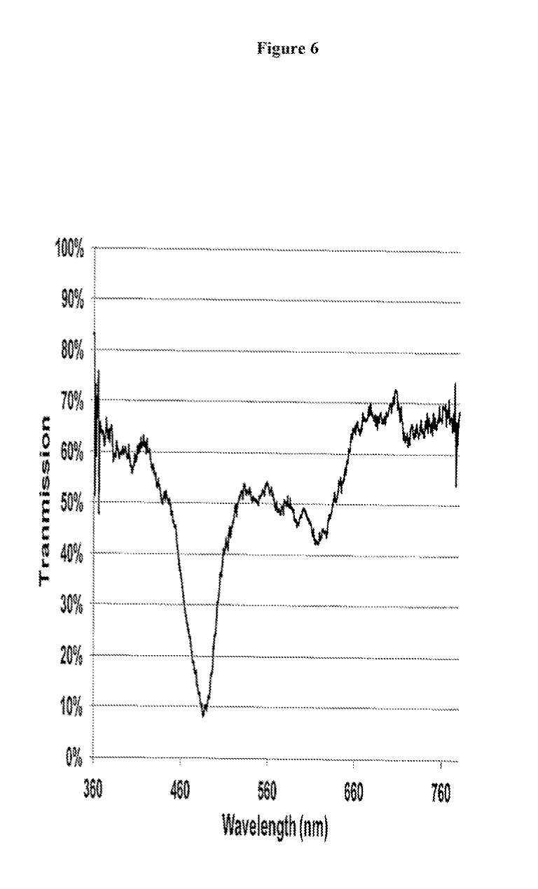

TABLE 6
Example 3 illustrates the ipRGC response Lux limits assuming
χ ≈ 9.55% stray light from sides. This data is also illustrated in FIG. 6.
ipRGC distribution function: R_{A} (λ)

| | Thresholds: μW/cm² | | |
|---|---|---|---|
| | Onset | 50% | saturation |
| | threshold; | threshold; | threshold; |
| | (Point A of | (Point B of | (Point C of |
| | FIG. 1) | FIG. 1) | FIG. 1) |
| | 4 | 5.5 | 18 |
| Lux @ | 121 | 167 | 545 |
| Standard | | | |
| illuminant A | | | |
| Lux @ | 54 | 74 | 243 |
| Standard | | | |
| illuminant F7 | | | |
| Lux @ | 51 | 71 | 230 |
| Standard | | | |
| illuminant | | | |
| D65 | | | |

TABLE 7
Example 4 illustrates the ipRGC response Lux limits assuming no stray
light (χ = 0) from sides. This data is further illustrated in FIG. 6.
ipRGC distribution function: R_{A} (λ)

| | Thresholds: μW/cm² | | |
|---|---|---|---|
| | Onset | 50% | saturation |
| | threshold; | threshold; | threshold; |
| | (Point A of | (Point B of | (Point C of |
| | FIG. 1) | FIG. 1) | FIG. 1) |
| | 4 | 5.5 | 18 |
| Lux @ | 207 | 284 | 930 |
| Standard | | | |
| illuminant A | | | |
| Lux @ | 92 | 128 | 412 |
| Standard | | | |
| illuminant F7 | | | |
| Lux @ | 88 | 121 | 394 |
| Standard | | | |
| illuminant | | | |
| D65 | | | |

TABLE 8
Example 4 illustrates exemplary ipRGC response Lux limits assuming
χ ≈ 9.55% stray liaht from sides. This data is also illustrated in FIG. 6.
ipRGC distribution function: R_{A} (λ)

| | Thresholds: μW/cm² | | |
|---|---|---|---|
| | Onset | 50% | saturation |
| | threshold; | threshold; | threshold; |
| | (Point A of | (Point B of | (Point C of |
| | FIG. 1) | FIG. 1) | FIG. 1) |
| | 4 | 5.5 | 18 |
| Lux @ | 175 | 241 | 788 |
| Standard | | | |
| illuminant A | | | |
| Lux @ | 79 | 108 | 352 |
| Standard | | | |
| illuminant F7 | | | |
| Lux @ | 75 | 102 | 334 |
| Standard | | | |
| illuminant | | | |
| D65 | | | |

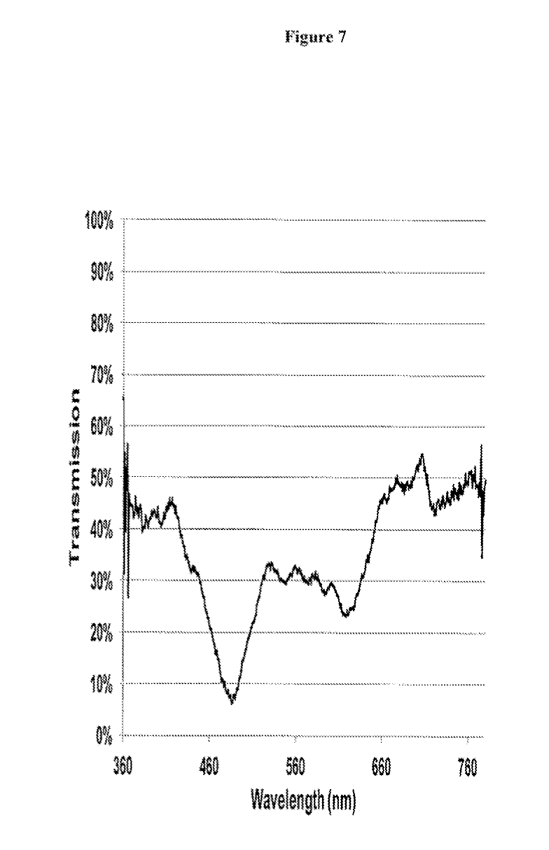

TABLE 9
Example 5 illustrates exemplary ipRGC response Lux limits assuming
no stray light (χ = 0) from sides. This data is also illustrated in FIG. 7.
ipRGC distribution function: R_{A} (λ)

| | Thresholds: μW/cm² | | |
|---|---|---|---|
| | Onset | 50% | saturation |
| | threshold; | threshold; | threshold; |
| | (Point A of | (Point B of | (Point C of |
| | FIG. 1) | FIG. 1) | FIG. 1) |
| | 4 | 5.5 | 18 |
| Lux @ | 334 | 460 | 1503 |
| Standard | | | |
| illuminant A | | | |
| Lux @ | 146 | 201 | 659 |
| Standard | | | |
| illuminant F7 | | | |
| Lux @ | 141 | 193 | 631 |
| Standard | | | |
| illuminant | | | |
| D65 | | | |

TABLE 10
Example 5 illustrates an exemplary ipRGC response Lux limits assuming
χ ≈ 9.55% stray light from sides. This data is also illustrated in FIG. 7.
ipRGC distribution function: R_{A} (λ)

| | Thresholds: μW/cm² | | |
|---|---|---|---|
| | Onset | | |
| | threshold; | | |
| | (Point A of | [symbol] | [symbol] |
| | FIG. 1) | FIG. 1) | FIG. 1) |
| | 4 | 5.5 | 18 |
| Lux @ | 248 | 340 | 1113 |
| Standard | | | |
| illuminant A | | | |
| Lux @ | 110 | 152 | 496 |
| Standard | | | |
| illuminant F7 | | | |
| Lux @ | 104 | 144 | 470 |
| Standard | | | |
| illuminant | | | |
| D65 | | | |

[symbol]

indicates data missing or illegible when filed

Table 11 illustrates an example of a sample calculation for illuminant optimization (no fitter). This data illustrates the different performance for unfiltered illuminants. It indicates that only very low levels of illumination appear to produce an ipRGC response, and that incandescent lighting appears to be significantly more beneficial. One can use the methods specified in this invention to optimize to Illuminants with, improved ipRGC response.

ipRGC distribution function: R_{A} (λ)

| | Thresholds: μW/cm² | | |
|---|---|---|---|
| | Onset | 50% | saturation |
| | threshold; | threshold; | threshold; |
| | (Point A of | (Point B of | (Point C of |
| | FIG. 1) | FIG. 1) | FIG. 1) |
| | 4 | 5.5 | 18 |
| Lux @ | 56 | 98 | 322 |
| Standard | | | |
| illuminant A | | | |
| Lux @ | 26 | 45 | 148 |
| Standard | | | |
| illuminant F7 | | | |
| Lux @ | 24 | 43 | 138 |
| Standard | | | |
| illuminant | | | |
| D65 | | | |

Table 12 is a summary of Illustrative exemplary essential luminance transmission, color, and color rendering parameters of example filters (data assumes D65 light)

| | CRI | | CRI | Luminous | L*a*b* | Perceived |
|---|---|---|---|---|---|---|
| | (CIE | CRI- | DE00- | transmis- | coordinates | color of |
| filter | 13.3) | 109¹ † | 109¹ ** | sion *** | of filter | filter |
| Example 1 | 44.7 | 33.6 | 74.0 | 39.6% | L* = 69.2 | brown |
| | | | | | a* = 1.92 | |
| | | | | | b* = 43.2 | |
| Example 2 | 83.4 | 82.4 | 91.9 | 94.3% | L* = 97.8 | Very pale |
| | | | | | a* = 6.51 | pink or |
| | | | | | b* = 7.13 | orange |
| Example 3 | 80.7 | 80.2 | 91.0 | 75.1% | L* = 89.4 | Pale gray |
| | | | | | a* = 5.07 | |
| | | | | | b* = 9.42 | |
| Example 4 | 79.8 | 80.2 | 90.9 | 46.9% | L* = 74.1 | gray |
| | | | | | a* = 3.42 | |
| | | | | | b* = 8.05 | |
| Example 5 | 79.4 | 80.2 | 90.9 | 28.4% | L* = 60.2 | Dark gray |
| | | | | | a* = 3.80 | |
| | | | | | b* = 4.85 | |

† for the color rendering method, uses the standard CIE 13.3 method but substitutes the color adaptation with CIE 109.2
** for the color rendering method, uses DE00 for the color difference and CIE 109.2 for the color adaptation. This data represent an example for illustration and are not meant to be absolute specifications. It is understood that other color difference and color adaptation methods may be used.
*** based on the standard photopic function. It is understood that other luminous efficiency functions (such as CIE Publication #86 “CIE 1988 2° Spectral Luminous Efficiency Function For Photopic Vision”) may also apply.

### Example 6

The following example describes an exemplary method of testing the design of a calculated optical filter, manufacturing the filter, and conducting a clinical test of the effect on a particular medical indication, specifically migraine headaches. Briefly, alternating layers of niobium pentoxide and tantalum pentoxide are deposited on borosilicate glass lens blanks (Corning, France) by any appropriate method e.g., chemical vapor deposition to yield the desired transmission profile (one example can be 23 layers). Other methods known in the art to create the desired spectral transmission profile for the optical filter can be employed by the skilled artisan. The estimated light transmission profile through a representative sample lens is shown in e.g., any one of FIGS. 3-7 or is otherwise calculated using the optimization methodology described herein based on. a selected ipRGC response control, a selected color rendering, and a selected luminous transmission. The filter notch for ipRGC response control can be a total of 20, 25, 30, 35, 40, 45, 50, 55, 60, 65, 70, 75 or more nm wide (can be one contiguous band or two, three, four, or five or more noncontiguous bands (e.g., 2 notches, 3, notches, 4 notches or 5 notches or more)), centered at 460, 465, 470, 475, 480, 485, 490, 495, 500, 505, 510, or 515_nm. Under these conditions, this filter blocks 10%, 20%, 30%, 40%, 50%, 60%, 70%, 80%, 90% or 95% or more of light constituting the ipRGC response range, and an average of 5%, 10%, 15%, 20%, 30%, 35%, 40%, 45%, 50% or more of total light across the visible spectrum, The color rendering of the eyeglasses can be greater than 10, 30, 50, 70, 75, 80, 85, or 90 in reference to CRI-109.

Initial clinical testing of this filtered lens will be conducted on a recruited patient population, of 20 men and women ages 18-40. All subjects will be non-smokers, who do not consume alcohol or caffeinated products within 30 days of the start of the study. Patients will also not be on prescription medication. To qualify for inclusion, subjects will be required to report chronic daily headache (Greater than 15 days of headache/month). The study will employ single subject control design, in which patients alternate 30 days of wearing the test lenses with 30 days of wearing placebo lenses (lenses tinted to a similar color and degree of total light transmission, without the notch filter properties). Patients will see a physician at the beginning of the study and at weekly intervals, and keep a diary of sell-reported episodes of headache, noting the severity and duration of the episode (arbitrary 1-10 scale). At the conclusion of the study, scores of headache duration and severity will be tabulated and compared between treatment conditions. Results will be statistically analyzed using one-tailed ANOVA. It is anticipated that a significant difference in headache severity and/or duration will be observed between use of filtered lenses and the placebo control. There may also be relevant sequellae including improved task performance or quality of life in other ways.

### Example 7

### Blepharospasm Clinical Trial

The purpose of this example is to demonstrate the effectiveness of the methods and products described in this application for treating blepharospasm.

Optimized optical filter eyeglass or illuminants as described herein that provide an ipRGC response control in a group of subject suffering from blepharospasm. A three arm study can be conducted for each optical filter or illuminant. A first can be for subjects using an optical filter (e.g., eyeglasses) that provide a selected ipRGC response control as described herein. A second arm can have “sham” eyeglasses that have similar optical, properties as the first except for the selected ipRGC response control characteristic. The third arm can be for subjects that are not treated, with eyeglasses.

The study can be conducted on several time frames. For example, the subject's eyes can be video-taped for e.g., 5 or 10 minutes prior to the use of the glasses and for 5 to 10 minutes after the use of the glasses to determine blink rates pre and post treatment. Furthermore, the study can assess the blink rate during certain periods during treatment. For example a treatment period of 1 hour, 2 hours, 4 hours, or any other time period can be conducted and the blink rate can be measured at different point in this time period. The blinks can also be measured using electrophysiological techniques to measure eye movements and blinks during the relevant period. Lastly, the subject can answer a questionnaire that rates their symptoms before and after treatment. The results of the study can be used to specify optimal ipRGC control (e.g., optical filters like eyewear) for treating blepharospasm. An additional study can include a longer term treatment with eyewear e.g., for 2 days, 3 day, 4 days, 1 week, or 2 weeks. The results of the studies can be analyzed by standard statistical analysis methods.

A similar study can be conducted using illuminants, as described herein, instead of eyewear.

All publications and patent applications mentioned in the specification are indicative of the level of those skilled in the art to which this invention pertains. All publications and patent applications are herein incorporated by reference to the same extent as if each individual publication or patent application was specifically and individually indicated, to be incorporated by reference and as far as they are consistent with the disclosure herein. The mere mentioning of the publications and patent applications does not necessarily constitute an admission that they are prior art to the instant application.

All of the COMPOSITIONS, METHODS and SYSTEMS disclosed and claimed herein can be made and executed, without undue experimentation in light of the present disclosure. While the compositions and methods of this Invention have been described In terms of particular embodiments, It will be apparent to those of skill in the art that variations may be applied to the COMPOSITIONS, METHODS and SYSTEMS and in the steps or in the sequence of steps of the methods described herein without departing from the concept, spirit and scope of the invention. More specifically, it will be apparent that certain agents that are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

1. An optical product comprising;
an ability to provide a spectrum of light to an individual in order to deliver a selected level of ipRGC response control,

2. The optical product of claim 1, wherein said spectrum of light has a selected color rendering.

3. The optical product of claim 1, wherein said optical product has a selected luminous transmission.

4. The optical product of claim 3, wherein said selected luminous transmission is selected from the group consisting of from about 5 to 98%, from about 15 to 25%, from about 25 to 35%, from about 35 to 45%, from about 45 to 55%, from about 55 to 65%, from about 65 to 75% from about 75 to 85%, from about 55 to 98%.

5. The optical product of claim 1, wherein said optical product is selected from the group consisting of an optical filter and an illuminant.

6. (canceled)

7. The optical product of claim 1, wherein said ipRGC response control pertains to the ipRGC initiation response.

8. The optical product of claim 7, wherein said ipRGC response control is selected from the group consisting of from between the ipRGC response initiation and 50% saturation of ipRGC response, about 50% saturation of ipRGC response, between 50% saturation and 100% ipRGC response saturation, about 100% saturation of ipRGC response and greater than 100% saturation of ipRGC response.

9. (canceled)

10. The optical product of claim 2, wherein said selected color rendering is an optimized color rendering.

11. (canceled)

12. (canceled)

13. (canceled)

14. The optical product of claim 1, wherein said ipRGC response control is sufficient to treat or prevent a disease or condition associated with ipRGC activity.

15. The optical product of claim 14, wherein said disease or condition is selected from the group consisting of migraine headache, blepharospasm, traumatic brain injury and circadian patterning disorder.

16. The optical product of claim 1, wherein said selected ipRGC response control includes blockage of a percentage of light having a selected wavelength or wavelengths selected from the group consisting of 10% or greater of light having a selected wavelength or wavelengths, 30% or greater of light having a selected wavelength or wavelengths, 50% or greater of light having a selected wavelength or wavelengths, 60% or greater of Sight having a selected wavelength or wavelengths, 70% or greater of light having a selected wavelength or wavelengths, 80% or greater of light having a selected wavelength or wavelengths, 90% or greater of light having a selected wavelength or wavelengths and 95% or greater of Sight having a selected wavelength or wavelengths.

17. The optical product of claim 16, wherein said blocking directs the selected wavelength or wavelengths of light to a different part of the spectrum.

18. The optical product of claim 17, wherein said blocking directs the selected wavelength or wavelengths of light to a spectrum of light outside of the spectrum that is between 480 nm to 520 nm.

19. The optical product of claim 16, wherein said center of the bandwidth of blocked light corresponds to a wavelength selected from the group consisting of 465 nm, 470 nm, 475 nm, 480 nm, 485 nm, 490 nm, 495 nm, 500 nm, 515 nm, 520 nm and 525 nm.

20. The optical product of claim 18, wherein the blocking of 20 nm to 110 of bandwidth of blocked light corresponds to blocking of bandwidths of light selected from the group consisting of two or more non-overlapping bandwidths of light that are at least 10 nm in bandwidth, three or more non-overlapping bandwidths of fight that are at least 6.7 nm in bandwidth, four or more non-overlapping bandwidths of light that are at least 5 nm in bandwidth, 5 or more non-overlapping bandwidths of light that are at least 4 nm in bandwidth and two or more non-overlapping bandwidths of light that are at least 10 nm in bandwidth.

21. The optical product of claim 5, wherein the predominant illuminant or predominant illuminant environment is selected from the group consisting of sunlight, incandescent, fluorescent, LED, OLED, mercury vapor lamp, sodium lamp, halogen lamp and electronic display.

22. A method of treating an ipRGC-associated disease or condition comprising;
providing an individual in need of treatment of an ipRGC-associated disease or condition with an optical product capable of providing a spectrum of light that effects a selected level of ipRGC response control.

23. The method of claim 22, wherein said disease or condition is selected from the group consisting of migraines, blepharospasm, traumatic brain injury and circadian patterning disorder

24. The method of claim 22, further comprising specifying the duration of use of said optical product.

25. (canceled)

26. (canceled)

27. (canceled)

28. (canceled)

29. (canceled)

30. A method of manufacturing an object for modulation of Sight for treating or preventing a disease or condition by modulation of an ipRGC response, comprising;
a) identifying an individual in need of an optical product capable of light modulation by modulation of ipRGC response;
b) determining the light environment of the individual;
c) selecting a filter for modulation of said light; and
d) manufacturing the object for modulation of said ipRGC response in order to treat or prevent a particular condition in said individual.

31. (canceled)

32. (canceled)

33. (canceled)

34. (canceled)

35. (canceled)

36. (canceled)

37. (canceled)

38. (canceled)
